(19) United States
(12) Patent Application Publication
(10) Pub. No.: US 2023/0086739 A1
(43) Pub. Date: Mar. 23, 2023

(54) MITIGATION OF SOLUTION CROSS-OVER USING DIFFERENTIAL ELECTROLYTE FORMULATIONS IN REDOX FLOW BATTERY SYSTEMS

(71) Applicant: UOP LLC, Des Plaines, IL (US)

(72) Inventors: Zara Osman, Glenview, IL (US); William T. Kender, Chicago, IL (US)

(21) Appl. No.: 17/822,460

(22) Filed: Aug. 26, 2022

Related U.S. Application Data
(60) Provisional application No. 63/261,442, filed on Sep. 21, 2021.

(51) Int. Cl. H01M 8/18

(52) U.S. Cl. CPC H01M 8/188; H01M 2300/0011

(57) ABSTRACT

A redox flow battery system having decreased cross-over of active species and decreased hydrogen generation, which is particularly important with less expensive polyethylene or polypropylene membranes. The redox flow battery system comprises at least one rechargeable cell comprising a positive electrolyte, a negative electrolyte, and a separator positioned between the positive electrolyte and the negative electrolyte. The positive electrolyte is in contact with a positive electrode, and the negative electrolyte is in contact with a negative electrode. The positive and negative electrolytes comprise water and a metal precursor, and the concentration of the metal precursor in the negative electrolyte is greater than the concentration of the metal precursor in the positive electrolyte. The metal in the metal precursor comprises iron, copper, zinc manganese, titanium, tin, silver, vanadium, or cerium.

### RELATED APPLICATIONS

This application claims priority to U.S. Provisional Patent Application Ser. No. 63/261,442, filed on Sep. 21, 2021, the entirety of which is incorporated herein by reference.

### BACKGROUND

The world electric generation capacity is expected to increase to more than 35,000 TWh by 2040, Global energy demand will likely expand by nearly 30% by 2040. Nearly 67% of electrical energy today is sourced from fossil fuels (coal (27%), natural gas (35%) and oil (5%)), 19% comes from nuclear energy, 7% from hydroelectric power, 8% from solar and wind power, with the remainder from biomass and other sources. The energy sourced from solar and wind has seen a rise from 3% in 2010 to 8% in 2019, and it continues to increase. Oil and natural gas production is expected to peak by 2030. By 2040 solar and wind power are projected to approach the energy generation from coal and account for more than 20% of global generation.

This is fueled in part by the fact that burning coal to produce 1 kWh of energy releases an average of 1000 g lifecycle CO₂, which is a major contributor to global warming. With tighter constraints on carbon emissions, a trend toward electrification of fossil-fuel based end uses is emerging. For example, about 30-50% of new vehicle purchases is projected to be plug-in hybrids by 2030. Currently, rechargeable intercalation batteries, such as lithium-ion batteries, which have high energy density and long cycle-life, are being developed. However, these systems face issues of safety and high cost, limiting their application.

Furthermore, a decrease in fossil fuel availability calls for the need to develop alternate sources of electricity. Among the most abundant sources are solar and wind power. For example, the amount of solar energy the earth receives in an hour is enough to meet energy demands worldwide for nearly a year. However, they suffer from significant drawbacks due to their inconsistency and unreliability given their dependency on factors such as cloud cover and wind speed.

One solution to utilizing these resources lies in the area of energy storage. Electrical energy storage (EES) stores energy when it is most readily available and releases it during times of peak need. However, currently only about 2.5% of the installed generation capacity in the United States is supplied from EES. The U.S. Department of Energy (DOE) has set targets of about 100% of total energy generation to be sourced from renewable sources by 2035, which equates to the need for nearly 1500 GW of new capacity. Also, California recently passed a law requiring electricity distribution networks to include energy storage systems capable of handling 2.25-5.00% of peak load.

EES devices face road-blocks to broad market penetration owing to their prohibitive costs of raw materials and fabrication, and relatively unsatisfactory performance.

Of the various technologies which are candidates for use with renewable energy, electrochemical storage devices or batteries comprise the largest group of technologies for stationary applications. Some of the earliest of these were the lead-acid battery (LAB) and nickel-metal batteries. Both had significant disadvantages including higher life-cycle cost due to limited cycling capability and high maintenance for LAB, and overcharge issues and low round trip efficiencies coupled with high cost of metals for Ni-metal batteries.

This led to the development of systems such as redox flow batteries (RFBs) and sodium-sulfur batteries which demonstrated up to a scale of multi MWs/MWhs.

RFBs have been proposed as promising choices for grid-scale storage systems. RFBs are particularly attractive due to their ability to decouple power and energy. The energy is stored in the volume of electrolyte while the power capability is determined by the size of the electrochemical cell stacks. Hence, they can deliver kilowatt to megawatt-hours of energy while mitigating system vulnerabilities such as uncontrolled energy release in the instance of a fault condition. Currently, the most widely studied RFBs are the traditional vanadium and zinc-based redox flow batteries. However, their applications are limited due to relatively low power and energy densities, and high costs.

The all-iron flow battery has been identified as a potential area of interest due to its low cost, environmental friendliness, and the abundance and low toxicity of iron. This system employs a Fe²⁺/Fe⁰ redox couple on the negative side and a Fe²⁺/Fe³⁺ redox couple on the positive side. There are drawbacks to IFBs including low conductivity of electrolytes, fouling of the membrane due to ion-crossover, and low efficiencies. One of the main issues with the electrolyte formulations on the negative side of the battery is the low coulombic efficiency due to the parasitic hydrogen evolution side reaction during iron plating. The reduction potential for iron plating is more negative than that of hydrogen evolution meaning that hydrogen evolution is thermodynamically favored during charging in an acidic solution. This results in issues such as reduced coulombic efficiency and an increase in the pH of the negative side which causes precipitation of iron oxides in the event of cross-over of active species from the positive side.

Therefore, there is a need for RFBs with reduced cross-over of active species, reduced hydrogen evolution, and improved coulombic, voltaic, and energy efficiencies.

### DESCRIPTION

This invention represents a unique solution which substantially improves the performance of RFBs under economically attractive conditions. It is directed toward providing electrolyte formulations which overcome challenges such as plating inefficiencies, hydrogen evolution, and cross-over of active species or water.

The redox flow battery system comprises at least one rechargeable cell comprising a positive electrolyte, a negative electrolyte, and a separator positioned between the positive electrolyte and the negative electrolyte. The positive electrolyte is in contact with a positive electrode, and the negative electrolyte is in contact with a negative electrode. The positive and negative electrolytes comprise water and a metal precursor, and the concentration of the metal precursor in the negative electrolyte is greater than a concentration of the metal precursor in the positive electrolyte. The metal in the metal precursor comprises iron, copper, zinc, manganese, titanium, tin, silver, vanadium, or cerium.

This redox flow battery system has been shown to store energy without significant capacity decay for a large number of cycles. It is capable of doing so by decreasing the kinetics of the parasitic hydrogen evolution reaction and decreasing the osmotic pressure between the anolyte and catholyte. Both of these act synergistically to support not only high performance, but a greater number of stable cycles.

Microporous membranes made from polyethylene or polypropylene are commercially available and cost-effective, e.g., Daramic® and Celgard® membranes. They have high conductivity to the supporting electrolyte, which increases voltaic efficiency, but they also have high conductivity to the active species and water, which decreases coulombic and voltaic efficiencies respectively. This represents a problem to the long-term performance of batteries using these membranes.

When the osmotic pressure differential is high, there are two main mechanisms through which the potential energy is released by the cell: (1) water movement into the catholyte and (2) Fe³⁺ movement, for example, into the anolyte. The first mechanism results in the dilution of the active species in the catholyte, and proportionally lowers the VE. The second mechanism directly reduces CE via a self-discharge method. By removing this driving force, the overall cell performance is greatly improved.

The volume movement across the membrane is reduced by utilizing differential metal concentrations on positive electrode and negative electrode sides of the battery. For instance, in one embodiment, 0.75 M FeCl₂ was employed on the positive side, while 1.25 M FeCl₂ was employed on the negative side. For a battery which has a ratio of 6:5 anolyte to catholyte, at 100% state of charge (SoC) on the positive side the resulting concentrations would be about 0.75 FeCl₂ on the negative side and 0.75 M FeCl₃ on the positive. This helps reduce osmotic pressure differences across the two sides compared to an equimolar system.

The invention has the added benefit of decreased hydrogen evolution. Since hydrogen evolution and iron plating are competing reactions near the electrode surface on the negative side of the battery, elevated levels of Fe²⁺, for example, favor the iron plating reaction over the reduction of H⁺, thereby helping to improve the coulombic efficiency.

The positive and negative electrolytes comprise water and a metal precursor. The metal in the metal precursor comprises iron, copper, zinc manganese, titanium, tin, silver, vanadium, or cerium.

The concentration of the metal precursor in the negative electrolyte is greater than the concentration of the metal precursor in the positive electrolyte. For example, when the metal precursor is FeCl₂, the concentration of the metal precursor in the negative electrolyte may be in the range of 1.0-4.5 M, or 1.0-3.0 M, and the concentration of the metal precursor in the positive electrolyte may be in the range of 0.5-4.0 M, or 1.0-2.5 M.

The positive and/or negative electrolyte may also contain at least one of an amino acid, an inorganic acid, an organic acid, a supporting electrolyte, and boric acid.

The amino acid may have a side chain length of 1 to 6 carbon atoms. Suitable amino acids include, but are not limited to, proline, glycine, alanine, valine, leucine, isoleucine, serine, and threonine. The concentration of the amino acid is typically in the range of 0.01 to 3.0 M, or 0.1 to 1.0 M.

Suitable inorganic acids include, but are not limited to, HF, HCl, HBr, HI, H₂SO₄, H₃PO₄, H₃BO₃ or combinations thereof. The concentration of the inorganic acid is typically in the range of 0.01 to 2.5 M, or 0.05 to 1.0 M.

Suitable organic acids include, but are not limited to, ascorbic acid, formic acid, acetic acid, citric acid, malic acid, tartaric acid, propionic acid, and butanoic acid. The concentration of the supporting electrolyte is typically in the range of 0.01 to 0.3M, or 0.05 to 0.1M.

The supporting electrolyte provides available and mobile ions to complete the charging circuit. These ions migrate through the separator in order to balance the charge developed from moving electrons through the external circuit from one electrode to the other. The supporting electrolyte contains one or more ions comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof. For example, the supporting electrolyte could be LiCl, NaCl, Na₂SO₄, KCl, NH₄Cl, and the like. The concentration of the supporting electrolyte is typically in the range of 1.0-5.0 M, or 2.0-4.0 M.

The separator may comprise an ionically conductive membrane, a solid ion exchange media (e.g., a ceramic such as NaSCION, or a porous diffusion medium (e.g., a porous ceramic or dense gel electrolyte). The ionically conductive membrane can be any ionically conductive membrane. Suitable ionically conductive membranes include, but are not limited to, ionically conductive thin film composite membranes, ionically conductive asymmetric composite membranes, size exclusion membranes, anion exchange membranes, or cation exchange membranes.

Ionically conductive thin film composite (TFC) membranes may comprise a microporous support membrane and a hydrophilic ionomeric polymer coating layer on the surface of the microporous support membrane, wherein the hydrophilic ionomeric polymer coating layer is ionically conductive. A TFC membrane is described in U.S. application Ser. No. 17/389,032, filed Jul. 29, 2021, entitled Ionically Conductive Thin Film Composite Membranes for Energy Storage Applications, which is incorporated herein by reference in its entirety.

Ionically conductive asymmetric composite membranes may comprise a microporous substrate membrane; and an asymmetric hydrophilic ionomeric polymer coating layer on a surface of the microporous substrate layer, the coating layer made of a hydrophilic ionomeric polymer, the coating layer comprising; a porous layer having a first surface and a second surface, the first surface of the porous layer on the surface of the microporous substrate layer; and a nonporous layer on the second surface of the porous layer; wherein the microporous substrate membrane is made from a polymer different from the hydrophilic ionomeric polymer. An ionically conductive asymmetric composite membrane is described in U.S. application Ser. No. 17/388,950, filed Jul. 29, 2021, entitled Ionically Conductive Asymmetric Composite Membranes for Electrochemical Energy System Applications, which is incorporated herein by reference in its entirety.

Size-exclusion membranes may comprise materials which prevent the movement of ions or molecules which are above a certain size. These membranes will allow ions below the pore size of the membrane while rejecting those which are larger. This can be useful in cases in which the active species in a RFB is larger than the supporting electrolyte ions.

Anion-exchange membranes may comprise —NH₃⁺, —NRH₂⁺, —NR₂H⁺, —NR₃⁺, or —SR₂⁻ anion exchange functional groups.

One example of an anion exchange membrane is a sandwich-structured thin film composite anion exchange membranes which may may comprise a microporous substrate membrane; a first hydrophilic ionomeric polymer coating layer on a surface of the microporous substrate membrane; a cross-linked protonated polymeric polyamine anion exchange layer on a second surface of the first hydrophilic ionomeric polymer coating layer; and a second hydrophilic ionomeric polymer coating layer on a second surface of the cross-linked protonated polymeric polyamine anion exchange layer. A sandwich-structured thin film composite anion exchange membrane is described in U.S. application Ser. No. 17/388,956, filed Jul. 29, 2021, entitled Sandwich-Structured Thin Film Composite Anion Exchange Membrane for Redox Flow Battery Applications, which is incorporated herein by reference in its entirety.

Cation-exchange membranes may comprise —SO₃⁻, —COO⁻, —PO₃²⁻, —PO₃H⁻, or —C₆H₄O⁻ cation exchange functional groups. The cation-exchange membrane can comprise a perfluorinated ionomer selected from, but is not limited to, Nafion®, Flemion®, NEOSEPTA®-F, a partially fluorinated polymer, a non-fluorinated hydrocarbon polymer, a non-fluorinated polymer with aromatic backbone, an acid-base blend, or combinations thereof.

Bipolar membranes may comprise both cation-exchange and anion-exchange polymers.

The hydrophilic ionomeric polymer in the TFC membrane, the asymmetric composite membrane, and the sandwich-structured thin film composite anion exchange membrane comprises a hydrophilic ionomeric polymer or a cross-linked hydrophilic polymer comprising repeat units of both electrically neutral repeating units and a fraction of ionized functional groups such as —SO₃⁻, —COO⁻, —PO₃²⁻, —PO₃H⁻, —C₆H₄O⁻, —O₄B⁻, —NH₃⁺, —NRH₂⁺, —NR₂H⁺, —NR₃⁺, or —SR₂⁻. The hydrophilic ionomeric polymer contains high water affinity polar or charged functional groups such as —SO₃⁻, —COO⁻ or —NH₃⁺ group. The cross-linked hydrophilic polymer comprises a hydrophilic polymer complexed with a complexing agent such as polyphosphoric acid, boric acid, a metal ion, or a mixture thereof. The hydrophilic ionomeric polymer not only has high stability in an aqueous electrolyte solution due to its insolubility in the aqueous electrolyte solution, but also has high affinity to water and charge-carrying ions such as H₃O⁺ or Cl⁻ due to the hydrophilicity and ionomeric property of the polymer and therefore high ionic conductivity and low membrane specific area resistance.

Suitable hydrophilic ionomeric polymers include, but are not limited to, a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, an alginate polymer such as sodium alginate, potassium alginate, calcium alginate, ammonium alginate, an alginic acid polymer, a hyaluronic acid polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a metal ion-complexed poly(acrylic acid) polymer, a boric acid-complexed poly(acrylic acid) polymer, a metal ion-complexed poly(methacrylic acid), a boric acid-complexed poly(methacrylic acid), or combinations thereof.

Various types of polysaccharide polymers may be used, including, but not limited to, chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, τ-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

The microporous support membrane in the TFC membrane, the asymmetric composite membrane, and the sandwich-structured thin film composite anion exchange membrane should have good thermal stability (stable up to at least 100° C.), high aqueous and organic solution resistance (insoluble in aqueous and organic solutions) under low pH condition (e.g., pH less than 6), high resistance to oxidizing and reducing conditions (insoluble and no performance drop under oxidizing and reducing conditions), high mechanical strength (no dimensional change under the system operation conditions), as well as other factors dictated by the operating conditions for energy storage applications. The microporous support membrane must be compatible with the cell chemistry and meet the mechanical demands of cell stacking or winding assembly operations. The microporous support membrane has high ionic conductivity, but low selectivity of charge-carrying ions such as protons, hydrated protons, chloride ions, potassium ions, hydrated potassium ions, sodium ions, and hydrated sodium ions over the electrolytes such as ferric ions, hydrated ferric ions, ferrous ions, and hydrated ferrous ions.

The polymers suitable for the preparation of the microporous support membrane can be selected from, but not limited to, polyolefins such as polyethylene and polypropylene, polyamide such as Nylon 6, Nylon 6,6, polyacrylonitrile, polyethersulfone, sulfonated polyethersulfone, polysulfone, sulfonated polysulfone, poly(ether ketone), sulfonated poly(ether ketone), polyester, cellulose acetate, cellulose triacetate, polybenzimidazole, polyimide, polyvinylidene fluoride, polycarbonate, cellulose, or combinations thereof. These polymers provide a range of properties such as low cost, high stability in water and electrolytes under a wide range of pH, good mechanical stability, and ease of processability for membrane fabrication.

The microporous support membrane can have either a symmetric porous structure or an asymmetric porous structure. The asymmetric microporous support membrane can be formed by a phase inversion membrane fabrication approach followed by direct air drying, or by phase inversion followed by solvent exchange methods. The microporous support membrane also can be fabricated via a dry processing of thermoplastic polyolefins or a wet processing of thermoplastic olefins. The dry processing of thermoplastic polyolefins utilizes extrusion to bring the polymer above its melting point and form it into the desired shape. Subsequent annealing and stretching processes may also be done to increase the crystallinity and orientation and dimension of the micropores. The wet processing of polyolefin separators is done with the aid of a hydrocarbon liquid or low molecular weight oil mixed with the polymer resin or a mixture of the polymer resin and inorganic nanoparticles in the melt phase. The melt mixture is extruded through a die similar to the dry processed separators. The thickness of the microporous support membrane can be in a range of 10-1000 micrometers, or a range of 10-900 micrometers, or a range of 10-800 micrometers, or a range of 10-700 micrometers, or a range of 10-600 micrometers, or a range of 10-500 micrometers, or a range of 20-500 micrometers. The pore size of the microporous membrane can be in a range of 10 nanometers to 50 micrometers, or a range of 50 nanometers to 10 micrometers, or a range of 0.2 micrometers to 1 micrometer.

The operating temperature of the redox flow battery system is in a range of 10° C. to 90° C., or 20° C. to 65° C.

One aspect of the invention is a redox flow battery system. In one embodiment, the redox flow battery system comprises: at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode; the positive electrolyte comprising water and a metal precursor; and the negative electrolyte comprising water and the metal precursor; wherein a concentration of the metal precursor in the negative electrolyte is greater than a concentration of the metal precursor in the positive electrolyte; and wherein the metal in the metal precursor comprises iron, copper, zinc manganese, titanium, tin, silver, vanadium, or cerium.

In some embodiments, the metal comprises iron or copper.

In some embodiments, the metal comprises iron, and the metal precursor comprises FeCl₂, FeCl₃, FeSO₄, Fe₂(SO₄)₃, FeO, Fe, Fe₂O₃, or combinations thereof;

In some embodiments, the metal precursor in the negative electrolyte comprises FeCl₂ at a concentration of 1.0-4.5 M; and the metal precursor in the positive electrolyte comprises FeCl₂, at a concentration of 0.5-4.0 M.

In some embodiments, the separator comprises an ionically conductive membrane.

In some embodiments, the ionically conductive membrane comprises an ionically conductive thin film composite membrane, an ionically conductive asymmetric composite membrane, a size exclusion membrane, an anion exchange membrane, or a cation exchange membrane.

In some embodiments, the positive electrolyte, the negative electrolyte, or both further comprise at least one of: an amino acid, an inorganic acid, an organic acid, a supporting electrolyte, and boric acid.

In some embodiments, at least one of: the amino acid comprises an amino acid having a side chain length of 1 to 6 carbon atoms; the inorganic acid comprises HCl, H₂SO₄, or combinations thereof; and the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof.

In some embodiments, the negative electrolyte comprises FeCl₂ at the concentration of 1.0-4.5 M; NaCl, KCl, NH₄Cl, or combinations thereof; optionally HCl; optionally boric acid; optionally glycine; and optionally FeCl₃; and the positive electrolyte comprises FeCl₂ at the concentration of 0.5-4.0 M; NaCl, KCl, NH₄Cl, or combinations thereof; optionally HCl; optionally glycine; optionally boric acid; and optionally FeCl₃.

In some embodiments, the volume of the negative electrolyte is less than the volume of the positive electrolyte.

Another aspect of the invention is a redox flow battery system. In one embodiment, the redox flow battery system comprises: at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode; the positive electrolyte comprising water and a metal precursor; and the negative electrolyte comprising water and the metal precursor; wherein a concentration of the metal precursor in the negative electrolyte is greater than a concentration of the metal precursor in the positive electrolyte; wherein the metal in the metal precursor comprises iron; and wherein the metal precursor comprises FeCl₂, FeCl₃, FeSO₄, Fe₂(SO₄)₃, FeO, Fe, Fe₂O₃, or combinations thereof.

In some embodiments, the metal precursor in the negative electrolyte comprises FeCl₂ at the concentration of 1.0-4.5 M; and the metal precursor in the positive electrolyte comprises FeCl₂, at the concentration of 0.5-4.0 M.

In some embodiments, the separator is an ionically conductive membrane.

In some embodiments, the ionically conductive membrane is an ionically conductive thin film composite membrane, an ionically conductive asymmetric composite membrane, a size exclusion membrane, an anion exchange membrane, or a cation exchange membrane.

In some embodiments, the positive electrolyte, the negative electrolyte, or both further comprise at least one of: an amino acid, an inorganic acid, a supporting electrolyte, and boric acid.

In some embodiments, at least one of: the amino acid comprises an amino acid having a side chain length of 1 to 6 carbon atoms; the inorganic acid comprises HCl, H₂SO₄, or combinations thereof; and the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof.

In some embodiments, the negative electrolyte comprises FeCl₂ at the concentration of 1.0-4.5 M; NaCl, KCl, NH₄Cl, or combinations thereof; optionally HCl; optionally boric acid; optionally glycine; and optionally FeCl₃; and the positive electrolyte comprises FeCl₂ at the concentration of 0.5-4.0 M; NaCl, KCl, NH₄Cl, or combinations thereof; optionally HCl; optionally glycine, optionally boric acid, and optionally FeCl₃.

In some embodiments, the volume of the negative electrolyte is less than the volume of the positive electrolyte.

Another aspect of the invention is a redox flow battery system. In one embodiment, the redox flow battery system comprises: at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode; the positive electrolyte comprising water and a metal precursor; and the negative electrolyte comprising water and the metal precursor; wherein a concentration of the metal precursor in the negative electrolyte is greater than a concentration of the metal precursor in the positive electrolyte; wherein the metal in the metal precursor comprises iron; wherein the metal precursor comprises FeCl₂, FeCl₃, FeSO₄, Fe₂(SO₄)₃, FeO, Fe, Fe₂O₃, or combinations thereof; and wherein the positive electrolyte, the negative electrolyte, or both further comprise at least one of: an amino acid, an inorganic acid, a supporting electrolyte, and boric acid.

In some embodiments, the positive electrolyte, the negative electrolyte, or both further comprise at least one of: an amino acid, an inorganic acid, a supporting electrolyte, and boric acid; and wherein at least one of: the amino acid comprises an amino acid having a side chain length of 1 to 6 carbon atoms; the inorganic acid comprises HCl, H₂SO₄, or combinations thereof; and the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof.

In some embodiments, the negative electrolyte comprises FeCl₂ at the concentration of 1.0-4.5 M; NaCl, KCl, NH₄Cl, or combinations thereof; optionally HCl; optionally boric acid; optionally glycine; and optionally FeCl₃; and the positive electrolyte comprises FeCl₂ at the concentration of 0.5-4.0 M; NaCl, KCl, NH₄Cl, or combinations thereof; optionally HCl; optionally glycine; optionally boric acid; and optionally FeCl₃.

### EXAMPLES

### Example 1

### Anolyte Formulation Procedure

The negative electrolyte solution comprised 2.5M FeCl₂, 3.0M NH₄Cl, and 0.2M glycine. It was prepared by dissolving FeCl₂.4H₂O in deaerated 18.2 MΩcm, followed by the addition of NH₄Cl. Glycine was then added. All steps were performed under constant N₂ purge. The pH was adjusted to about 1.5 using HCl. The volume was adjusted to achieve the desired concentrations.

### Catholyte Formulation Procedure

The positive electrolyte solution comprised 1.5M FeCl₂, 3.0M NH₄Cl, and 0.2M glycine. It was prepared by dissolving FeCl₂.4H₂O in deaerated 18.2 MΩcm, followed by the addition of NH₄Cl and then glycine. All steps were performed under constant N₂ purge. The pH was adjusted to about 1.5 using HCl. The volume was adjusted to achieve the desired concentrations.

### Solution Cross-Over Testing

120 ml of anolyte and 200 ml of catholyte were loaded into a 25 cm² IFB, and the battery was cycled at 12 mA/cm² for 21 h. The test was conducted at room temperature using a porous membrane known to allow for water crossover.

This battery showed no solution movement after 21 h of charging, while another battery which had 1.5M FeCl₂ on both sides showed about 10% volume movement toward the catholyte at end of ˜21 h of charging.

### Example 2

### Anolyte Formulation Procedure

The negative electrolyte solution comprised 1.25 M FeCl₂, 2.0M NaCl, and 0.2M boric acid. It was prepared by dissolving FeCl₂.4H₂O in deaerated 18.2 MΩcm, followed by the addition NaCl, Then, boric was added. All steps were performed under constant N₂ purge. The pH was adjusted to about 1.5 using HCl. The volume was adjusted to achieve the desired concentrations.

### Catholyte Formulation Procedure

The positive electrolyte solution comprised 0.75 M FeCl₂, 2.0 M NaCl, and 0.2M boric. It was prepared by dissolving FeCl₂.4H₂O in deaerated 18.2 MΩcm, followed by the addition NaCl. Boric was then added. All steps were performed under constant N₂ purge. The pH was adjusted to about 1.5 using HCl. The volume was adjusted to achieve the desired concentrations.

### Solution Cross-Over Testing

120 ml of anolyte and 100 ml of catholyte were loaded into a 25 cm² IFB, and the battery was cycled with 2 h charge and discharge at 30 mA/cm². The test was conducted at room temperature using a porous membrane known to allow for water crossover.

### SPECIFIC EMBODIMENTS

While the following is described in conjunction with specific embodiments, it will be understood that this description is intended to illustrate and not limit the scope of the preceding description and the appended claims.

A first embodiment of the invention is a system, comprising at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode; the positive electrolyte comprising water and a metal precursor; and the negative electrolyte comprising water and the metal precursor; wherein a concentration of the metal precursor in the negative electrolyte is greater than a concentration of the metal precursor in the positive electrolyte; and wherein the metal in the metal precursor comprises iron, copper, zinc manganese, titanium, tin, silver, vanadium, or cerium. An embodiment of the invention is one, any or all of prior embodiments in this paragraph up through the first embodiment in this paragraph wherein the metal comprises iron or copper. An embodiment of the invention is one, any or all of prior embodiments in this paragraph up through the first embodiment in this paragraph wherein the metal comprises iron and wherein the metal precursor comprises FeCl₂, FeCl₃, FeSO₄, Fe₂(SO₄)₃, FeO, Fe, Fe₂O₃, or combinations thereof; An embodiment of the invention is one, any or all of prior embodiments in this paragraph up through the first embodiment in this paragraph wherein the metal precursor in the negative electrolyte comprises FeCl₂ at the concentration of 1.0-4.5 M; and the metal precursor in the positive electrolyte comprises FeCl₂, at the concentration of 0.5-4.0 M. An embodiment of the invention is one, any or all of prior embodiments in this paragraph up through the first embodiment in this paragraph wherein the separator comprises an ionically conductive membrane. An embodiment of the invention is one, any or all of prior embodiments in this paragraph up through the first embodiment in this paragraph wherein the ionically conductive membrane comprises an ionically conductive thin film composite membrane, an ionically conductive asymmetric composite membrane, a size exclusion membrane, an anion exchange membrane, or a cation exchange membrane. An embodiment of the invention is one, any or all of prior embodiments in this paragraph up through the first embodiment in this paragraph wherein the positive electrolyte, the negative electrolyte, or both further comprise at least one of an amino acid, an inorganic acid, an organic acid, a supporting electrolyte, and boric acid. An embodiment of the invention is one, any or all of prior embodiments in this paragraph up through the first embodiment in this paragraph wherein at least one of the amino acid comprises an amino acid having a side chain length of 1 to 6 carbon atoms; the inorganic acid comprises HCl, H₂SO₄, or combinations thereof; and the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof. An embodiment of the invention is one, any or all of prior embodiments in this paragraph up through the first embodiment in this paragraph wherein the negative electrolyte comprises FeCl₂ at the concentration of 1.0-4.5 M; NaCl, KCl, NH₄Cl, or combinations thereof; optionally HCl; optionally boric acid; optionally glycine; and optionally FeCl₃; and the positive electrolyte comprises FeCl₂ at the concentration of 0.5-4.0 M; NaCl, KCl, NH₄Cl, or combinations thereof; optionally HCl; optionally glycine; optionally boric acid; and optionally FeCl₃. An embodiment of the invention is one, any or all of prior embodiments in this paragraph up through the first embodiment in this paragraph wherein a volume of the negative electrolyte is less than a volume of the positive electrolyte.

A second embodiment of the invention is a redox flow battery system, comprising at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode; the positive electrolyte comprising water and a metal precursor; and the negative electrolyte comprising water and the metal precursor; wherein a concentration of the metal precursor in the negative electrolyte is greater than a concentration of the metal precursor in the positive electrolyte; wherein the metal in the metal precursor comprises iron; and wherein the metal precursor comprises FeCl₂, FeCl₃, FeSO₄, Fe₂(SO₄)₃, FeO, Fe, Fe₂O₃, or combinations thereof. An embodiment of the invention is one, any or all of prior embodiments in this paragraph up through the second embodiment in this paragraph wherein the metal precursor in the negative electrolyte comprises FeCl₂ at the concentration of 1.0-4.5 M; and the metal precursor in the positive electrolyte comprises FeCl₂, at the concentration of 0.5-4.0 M. An embodiment of the invention is one, any or all of prior embodiments in this paragraph up through the second embodiment in this paragraph wherein the separator is an ionically conductive membrane. An embodiment of the invention is one, any or all of prior embodiments in this paragraph up through the second embodiment in this paragraph wherein the ionically conductive membrane is an ionically conductive thin film composite membrane, an ionically conductive asymmetric composite membrane, a size exclusion membrane, an anion exchange membrane, or a cation exchange membrane. An embodiment of the invention is one, any or all of prior embodiments in this paragraph up through the second embodiment in this paragraph wherein the positive electrolyte, the negative electrolyte, or both further comprise at least one of an amino acid, an inorganic acid, a supporting electrolyte, and boric acid. An embodiment of the invention is one, any or all of prior embodiments in this paragraph up through the second embodiment in this paragraph wherein at least one of the amino acid comprises an amino acid having a side chain length of 1 to 6 carbon atoms; the inorganic acid comprises HCl, H₂SO₄, or combinations thereof; and the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof. An embodiment of the invention is one, any or all of prior embodiments in this paragraph up through the second embodiment in this paragraph wherein the negative electrolyte comprises FeCl₂ at the concentration of 1.0-4.5 M; NaCl, KCl, NH₄Cl, or combinations thereof; optionally HCl; optionally boric acid, optionally glycine, and optionally FeCl₃; and the positive electrolyte comprises FeCl₂ at the concentration of 0.5-4.0 M; NaCl, KCl, NH₄Cl, or combinations thereof; optionally HCl; optionally glycine; optionally boric acid; and optionally FeCl₃. An embodiment of the invention is one, any or all of prior embodiments in this paragraph up through the second embodiment in this paragraph wherein a volume of the negative electrolyte is less than a volume of the positive electrolyte.

A third embodiment of the invention is a redox flow battery system, comprising at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode; the positive electrolyte comprising water and a metal precursor; and the negative electrolyte comprising water and the metal precursor; wherein a concentration of the metal precursor in the negative electrolyte is greater than a concentration of the metal precursor in the positive electrolyte; wherein the metal in the metal precursor comprises iron; wherein the metal precursor comprises FeCl₂, FeCl₃, FeSO₄, Fe₂(SO₄)₃, FeO, Fe, Fe₂O₃, or combinations thereof; and wherein the positive electrolyte, the negative electrolyte, or both further comprise at least one of an amino acid, an inorganic acid, a supporting electrolyte, and boric acid. An embodiment of the invention is one, any or all of prior embodiments in this paragraph up through the third embodiment in this paragraph wherein the positive electrolyte, the negative electrolyte, or both further comprise at least one of an amino acid, an inorganic acid, a supporting electrolyte, and boric acid; and wherein at least one of the amino acid comprises an amino acid having a side chain length of 1 to 6 carbon atoms; the inorganic acid comprises HCl, H₂SO₄, or combinations thereof; and the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof. An embodiment of the invention is one, any or all of prior embodiments in this paragraph up through the third embodiment in this paragraph wherein the negative electrolyte comprises FeCl₂ at the concentration of 1.0-4.5 M; NaCl, KCl, NH₄Cl, or combinations thereof; optionally HCl; optionally boric acid; optionally glycine; and optionally FeCl₃; and the positive electrolyte comprises FeCl₂ at the concentration of 0.5-4.0 M; NaCl, KCl, NH₄Cl, or combinations thereof; optionally HCl; optionally glycine; optionally boric acid; and optionally FeCl₃.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A redox flow battery system, comprising:
at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode;
the positive electrolyte comprising water and a metal precursor; and
the negative electrolyte comprising water and the metal precursor;
wherein a concentration of the metal precursor in the negative electrolyte is greater than a concentration of the metal precursor in the positive electrolyte; and
wherein the metal in the metal precursor comprises iron, copper, zinc manganese, titanium, tin, silver, vanadium, or cerium.

2. The battery system of claim 1 wherein the metal comprises iron or copper.

3. The battery system of claim 1 wherein the metal comprises iron and wherein the metal precursor comprises FeCl₂, FeCl₃, FeSO₄, Fe₂(SO₄)₃, FeO, Fe, Fe₂O₃, or combinations thereof.

4. The battery system of claim 1 wherein:
the metal precursor in the negative electrolyte comprises FeCl₂ at the concentration of 1.0-4.5 M; and
the metal precursor in the positive electrolyte comprises FeCl₂, at the concentration of 0.5-4.0 M.

5. The battery system of claim 1 wherein the separator comprises an ionically conductive membrane.

6. The battery system of claim 5 wherein the ionically conductive membrane comprises an ionically conductive thin film composite membrane, an ionically conductive asymmetric composite membrane, a size exclusion membrane, an anion exchange membrane, or a cation exchange membrane.

7. The battery system of claim 1 wherein the positive electrolyte, the negative electrolyte, or both further comprise at least one of: an amino acid, an inorganic acid, an organic acid, a supporting electrolyte, and boric acid.

8. The battery system of claim 7 wherein at least one of:
the amino acid comprises an amino acid having a side chain length of 1 to 6 carbon atoms;
the inorganic acid comprises HCl, H₂SO₄, or combinations thereof; and
the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof.

9. The battery system of claim 1 wherein:
the negative electrolyte comprises FeCl₂ at the concentration of 1.0-4.5 M; NaCl, KCl, NH₄Cl, or combinations thereof; optionally HCl; optionally boric acid; optionally glycine; and optionally FeCl₃; and
the positive electrolyte comprises FeCl₂ at the concentration of 0.5-4.0 M; NaCl, KCl, NH₄Cl, or combinations thereof; optionally HCl; optionally glycine; optionally boric acid; and optionally FeCl₃.

10. The battery system of claim 1 wherein a volume of the negative electrolyte is less than a volume of the positive electrolyte.

11. A redox flow battery system, comprising:
at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode;
the positive electrolyte comprising water and a metal precursor; and
the negative electrolyte comprising water and the metal precursor;
wherein a concentration of the metal precursor in the negative electrolyte is greater than a concentration of the metal precursor in the positive electrolyte;
wherein the metal in the metal precursor comprises iron; and
wherein the metal precursor comprises FeCl₂, FeCl₃, FeSO₄, Fe₂(SO₄)₃, FeO, Fe, Fe₂O₃, or combinations thereof.

12. The battery system of claim 11 wherein:
the metal precursor in the negative electrolyte comprises FeCl₂ at the concentration of 1.0-4.5 M; and
the metal precursor in the positive electrolyte comprises FeCl₂, at the concentration of 0.5-4.0 M.

13. The battery system of claim 11 wherein the separator is an ionically conductive membrane comprising an ionically conductive thin film composite membrane, an ionically conductive asymmetric composite membrane, a size exclusion membrane, an anion exchange membrane, or a cation exchange membrane.

14. The battery system of claim 11 wherein the positive electrolyte, the negative electrolyte, or both further comprise at least one of: an amino acid, an inorganic acid, a supporting electrolyte, and boric acid.

15. The battery system of claim 14 wherein at least one of:
the amino acid comprises an amino acid having a side chain length of 1 to 6 carbon atoms;
the inorganic acid comprises HCl, H₂SO₄, or combinations thereof; and
the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof.

16. The battery system of claim 11 wherein:
the negative electrolyte comprises FeCl₂ at the concentration of 1.0-4.5 M; NaCl, KCl, NH₄Cl, or combinations thereof; optionally HCl; optionally boric acid; optionally glycine; and optionally FeCl₃; and
the positive electrolyte comprises FeCl₂ at the concentration of 0.5-4.0 M; NaCl, KCl, NH₄Cl, or combinations thereof; optionally HCl; optionally glycine; optionally boric acid; and optionally FeCl₃.

17. The battery system of claim 11 wherein a volume of the negative electrolyte is less than a volume of the positive electrolyte.

18. A redox flow battery system, comprising:
at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode;
the positive electrolyte comprising water and a metal precursor; and
the negative electrolyte comprising water and the metal precursor;
wherein a concentration of the metal precursor in the negative electrolyte is greater than a concentration of the metal precursor in the positive electrolyte;
wherein the metal in the metal precursor comprises iron;
wherein the metal precursor comprises FeCl₂, FeCl₃, FeSO₄, Fe₂(SO₄)₃, FeO, Fe, Fe₂O₃, or combinations thereof; and
wherein the positive electrolyte, the negative electrolyte, or both further comprise at least one of: an amino acid, an inorganic acid, a supporting electrolyte, and boric acid.

19. The battery system of claim 18 wherein the positive electrolyte, the negative electrolyte, or both further comprise at least one of: an amino acid, an inorganic acid, a supporting electrolyte, and boric acid; and
wherein at least one of:
the amino acid comprises an amino acid having a side chain length of 1 to 6 carbon atoms;
the inorganic acid comprises HCl, H₂SO₄, or combinations thereof; and
the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof.

20. The battery system of claim 18 wherein:
the negative electrolyte comprises FeCl₂ at the concentration of 1.0-4.5 M; NaCl, KCl, NH₄Cl, or combinations thereof; optionally HCl; optionally boric acid; optionally glycine; and optionally FeCl₃; and
the positive electrolyte comprises FeCl₂ at the concentration of 0.5-4.0 M; NaCl, KCl, NH₄Cl, or combinations thereof; optionally HCl; optionally glycine; optionally boric acid; and optionally FeCl₃.
